(19) United States
(12) Patent Application Publication
(10) Pub. No.: US 2014/0169638 A1
(43) Pub. Date: Jun. 19, 2014

(54) SPOT SEARCH DEVICE AND SPOT SEARCH METHOD

(71) Applicant: FUJITSU SEMICONDUCTOR LIMITED, Yokohama (JP)

(72) Inventor: Keisuke Toribami, Sendai (JP)

(73) Assignee: FUJITSU SEMICONDUCTOR LIMITED, Yokohama (JP)

(21) Appl. No.: 14/069,141

(22) Filed: Oct. 31, 2013

(30) Foreign Application Priority Data
Dec. 19, 2012 (JP) 2012-276953

(51) Int. Cl. G06T 7/20; G06K 9/00

(52) U.S. Cl. CPC G06T 7/20; G06K 9/00342
USPC 382/107

(57) ABSTRACT

A spot search device which searches, based on image data of pattern light, a moved spotlight representing any of the plurality of spotlights that has moved, the spot search device includes, a first movement amount generating unit which detects the moved spotlight and calculates a first movement amount based on first image data, a second movement amount generating unit which, based on the first movement amount and a distance, calculates a second movement amount of the moved spotlight in second image data; and a spotlight position predicting unit which, when a velocity and an area of the moved spotlight calculated from at least two pieces of frame image data satisfy reference values, detects the moved spotlight as a same object moved spotlight group and predicts a predicted moved spotlight position of the same object moved spotlight group in a next frame, based on movement information.

### CROSS-REFERENCE TO RELATED APPLICATION

This application is based upon and claims the benefit of priority of the prior Japanese Patent Application No. 2012-276953, filed on Dec. 19, 2012, the entire contents of which are incorporated herein by reference.

### FIELD

The embodiment discussed herein is relates to a spot search device and a spot search method.

### BACKGROUND

Conventionally, detectors which detect a movement or a motion of a measurement object such as a person in a three-dimensional space have been proposed (for example, Japanese Patent Application Laid-open No. 2005-3367). With a detector, for example, a pattern constituted by a plurality of spotlights is projected onto a three-dimensional space from above, and the projected spotlights are captured at an angle to generate image data. When a spotlight is projected onto a measurement object, the spotlight moves from its original position.

In consideration thereof, based on image data before and after movement of a spotlight, the detector acquires a movement distance of the spotlight in the image data. In addition, based on the movement distance of the spotlight, the detector measures a distance in the three-dimensional space using the principle of triangulation. Therefore, first, a correspondence of spotlights in image data before and after movement s preferably searched. In other words, with respect to image data before and after movement of spotlights, a search is preferably performed regarding to which position each spotlight had moved and a movement amount of the spotlight is preferably acquired.

However, with respect to image data after movement, an overleap phenomenon of a spotlight may occur due to a height of a measurement object or the like. The greater the height of a measurement object, the greater the movement amount of a spotlight. In such cases, an overleap phenomenon may occur in which a first spotlight that has moved (a moved spotlight) leaps over a second spotlight that had been adjacent to the first spotlight in the image data before movement (an adjacent spotlight). Accordingly, the moved spotlight ends up being erroneously determined to have moved from the adjacent spotlight and a spotlight search error occurs. This prevents an accurate movement amount of a spotlight from being measured.

In consideration thereof, a movement amount of a spotlight is detected based on short-distance image data generated by an imaging device located at a short distance from a spotlight projector and long-distance image data generated by an imaging device located at a long distance from the spotlight projector. With short-distance image data, since the movement amount of a spotlight is small, an overleap phenomenon of the spotlight is less likely to occur. Therefore, a movement amount of a spotlight in long-distance image data is detected based on a movement amount of the spotlight in short-distance image data and a distance between the imaging devices responsible for the respective pieces of image data.

As described above, by detecting a movement amount for all spotlights based on short-distance image data and long-distance image data, accurate movement amounts of spotlights can be measured. However, when the number of spotlights increases, processing time for acquiring movement amounts of spotlights also increases.

### SUMMARY

According to a first aspect of the embodiment, a spot search device which searches, based on image data of pattern light including a plurality of spotlights projected in a lattice pattern by a projector, a moved spotlight representing any of the plurality of spotlights that has moved, the spot search device includes a first movement amount generating unit which detects the moved spotlight and calculates a first movement amount based on first image data of the pattern light generated by a first imaging device, a second movement amount generating unit which, based on the first movement amount and a distance between the first imaging device and a second imaging device, calculates a second movement amount of the moved spotlight in second image data of the pattern light generated by the second imaging device; and a spotlight position predicting unit which, when a velocity and an area of the moved spotlight calculated from at least two pieces of frame image data in the second image data satisfy reference values, detects the moved spotlight as a same object moved spotlight group and predicts a predicted moved spotlight position of the same object moved spotlight group in a next frame in the second image data, based on movement information of the same object moved spotlight group in the second image data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example diagram illustrating an example of a configuration of a spot search device 100 according the present embodiment.

FIG. 2 is an example of a block diagram of the spot search device 100 illustrated in FIG. 1.

FIG. 3 is an example diagram illustrating an example of positions of imaging devices 14 and 15 and a projector pp of the spot search device 100.

FIG. 4 is a diagram illustrating image data A ga1 and image data B gb1 which are generated by the imaging devices A and B.

FIG. 5 is a diagram illustrating movements of spotlights in image data A gat and the image data B gb2 when an object is present.

FIG. 6 is a flow chart illustrating processing by the spot search device 100 according to the present embodiment.

FIG. 7 is an example diagram illustrating image data ga3 and gb3 of the frame i+1×k which correspond to image data A and B.

FIG. 8 is an example diagram illustrating image data ga4 and gb4 of the frame i+2×k which correspond to image data A and B.

FIG. 9 is a diagram illustrating a detection process of a same object moved spotlight group.

FIG. 10 is a diagram illustrating a process of predicting a position of a same object moved spotlight group in next-frame image data based on the movement information of the same object moved spotlight group.

FIG. 11 is a diagram illustrating a case where a predicted moved spotlight position is consistent within a reference value from a position of the same object moved spotlight group in image data gb5 of the next frame i+5 in the image data B.

FIG. 12 is a diagram illustrating a case where a predicted moved spotlight position is inconsistent within a reference value from a position of the same object moved spotlight group in image data gb6 of the next frame i+5 in the image data B.

FIG. 13 is a diagram illustrating a calculation process of an acceleration vector of a same object moved spotlight group.

FIG. 14 is a diagram illustrating a process of predicting a position of the same object moved spotlight group in next-frame image data in the image data B based on an acceleration vector.

### DESCRIPTION OF EMBODIMENTS

An embodiment of the present invention will be described below with reference to the drawings. It is to be noted that the technical scope of the present invention is not limited to the embodiment, and includes matters described in the claims and their equivalents.

[Configuration of Spot Search Device]

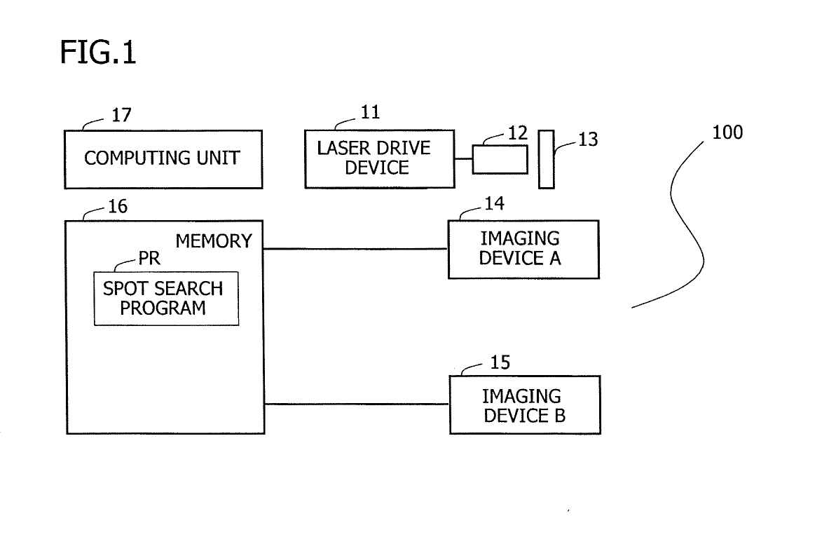

FIG. 1 is an example diagram illustrating an example of a configuration of a spot search device 100 according the present embodiment. For example, the spot search device 100 includes a laser drive device 11, a laser diode 12, a diffraction grating 13, an imaging device A 14, an imaging device B 15, a memory 16, and a computing unit 17. The imaging device A 14 and the imaging device B 15 are, for example, CCD cameras.

The laser drive device 11 drives the laser diode 12 to output a laser beam and the diffraction grating 13 diffracts the laser beam. The laser beam having passed through the diffraction grating 13 generates pattern light. The imaging device A 14 and the imaging device B 15 capture the pattern light projected onto an object area and generate image data. In addition, for example, the memory 16 stores a spot search program PR which controls a spot search process according to the present embodiment and stores generated image data. The computing unit 17 carries out overall control of the spot search device 100, and works in cooperation with the spot search program PR to realize the spot search process according to the present embodiment.

[Block Diagram of Spot Search Device]

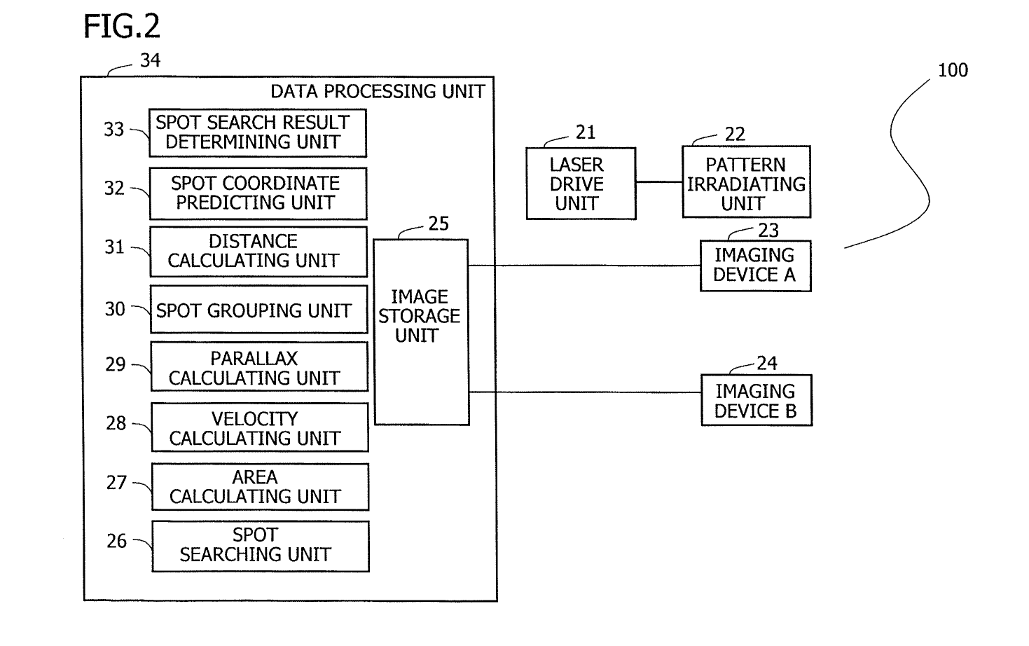

FIG. 2 is an example of a block diagram of the spot search device 100 illustrated in FIG. 1. The spot search device 100 according to FIG. 2 includes, for example, a laser drive unit 21, a pattern irradiating unit 22, an imaging unit A 23, an imaging unit B 24, and a data processing unit 34. In addition, the data processing unit 34 includes, for example, an image storage unit 25, a spot searching unit 26, an area calculating unit 27, a velocity calculating unit 28, a parallax calculating unit 29, a spot grouping unit 30, a distance calculating unit 31, a spot coordinate predicting unit 32, and a spot search result determining unit 33.

The imaging unit A 23 and the imaging unit B 24 respectively correspond to the imaging device A 14 and the imaging device B 15 in FIG. 1. In addition, the laser drive unit 21 corresponds to the laser drive device 11 in FIG. 1. The pattern irradiating unit 22 causes a laser beam driven by the laser drive unit 21 to pass through a diffraction grating and irradiates pattern light constituted by a plurality of spotlights. In this example, pattern light is projected in which a plurality of spotlights is aligned. In addition, the imaging unit A 23 and the imaging unit B 24 respectively generate image data of a region on which the pattern light had been irradiated.

The data processing unit 34 includes, for example, the image storage unit 25, the spot searching unit 26, the area calculating unit 27, the velocity calculating unit 28, the parallax calculating unit 29, the spot grouping unit 30, the distance calculating unit 31, the spot coordinate predicting unit 32, and the spot search result determining unit 33. The data processing unit 34 and the imaging unit A 23 and the imaging unit B 24 are electrically connected to each other, and the image storage unit 25 of the data processing unit 34 stores image data generated by the imaging unit A 23 and the imaging unit B 24.

Based on image data A generated by the imaging unit A 23, the spot searching unit 26 of the data processing unit 34 searches for a spotlight (a moved spotlight) that has moved in image data B generated by the imaging unit B 24. The area calculating unit 27 of the data processing unit 34 calculates an area of a region that corresponds to the moved spotlight and the velocity calculating unit 28 calculates a velocity between frames in a time series of the moved spotlight. In addition, the parallax calculating unit 29 calculates a movement amount from an original position of the moved spotlight as a parallax.

Furthermore, the spot grouping unit 30 of the data processing unit 34 judges whether or not the moved spotlight is to be assumed as a same object moved spotlight group based on information generated by the area calculating unit 27, the velocity calculating unit 28, and the parallax calculating unit 29. In addition, the distance calculating unit 31 calculates a distance between frames in a time series of the moved spotlight as velocity vector information. Furthermore, the spot coordinate predicting unit 32 predicts a position of the same object moved spotlight group in next-frame image data. In addition, the spot search result determining unit 33 judges whether or not a spotlight of the same object moved spotlight group is to be positioned at a predicted position of the same object moved spotlight group in the next-frame image data.

Next, positions of the imaging devices A and B illustrated in FIGS. 1 and 2 and a difference in pattern light based on a difference in positions will be described. First, a difference in positions of the imaging devices A and B will be described.

[Positional Correspondence Between Imaging Device and Projector]

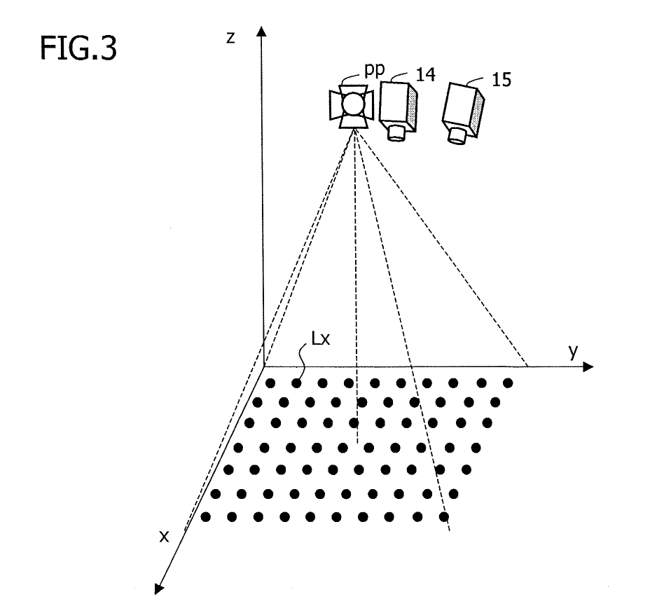

FIG. 3 is an example diagram illustrating an example of positions of imaging devices 14 and 15 and a projector pp of the spot search device 100. In FIG. 3, the imaging device 14 corresponds to the imaging device A 14 in FIG. 1 and the imaging device 15 corresponds to the imaging device B 15 in FIG. 1. In addition, the projector pp corresponds to the laser drive device 11, the laser diode 12, and the diffraction grating 13 in FIG. 1. In this example, a distance between the imaging device 14 and the projector pp is shorter than a distance between the imaging device 15 and the projector pp. Moreover, FIG. 3 illustrates a case where there is no object in a three-dimensional space onto which pattern light that is an imaging object is projected.

In the example illustrated in FIG. 3, the pattern light includes a plurality of spotlights Lx arranged in a square lattice shape. When an object that has a height is present in the three-dimensional space onto which the pattern light is projected, a position of the spotlight Lx moves in accordance with the height of the object. In this case, a movement amount of the spotlight Lx in image data A generated by the imaging device 14 at a short distance from the projector pp is small, and a movement amount of the spotlight Lx in image data B generated by the imaging device 15 at a long distance from the projector pp is large. This is because an angle between a projection direction of the pattern light by the projector pp and an imaging direction by the imaging device is smaller in the case of the imaging device 14 than in the case of the imaging device 15.

[Image Data A, Image Data B]

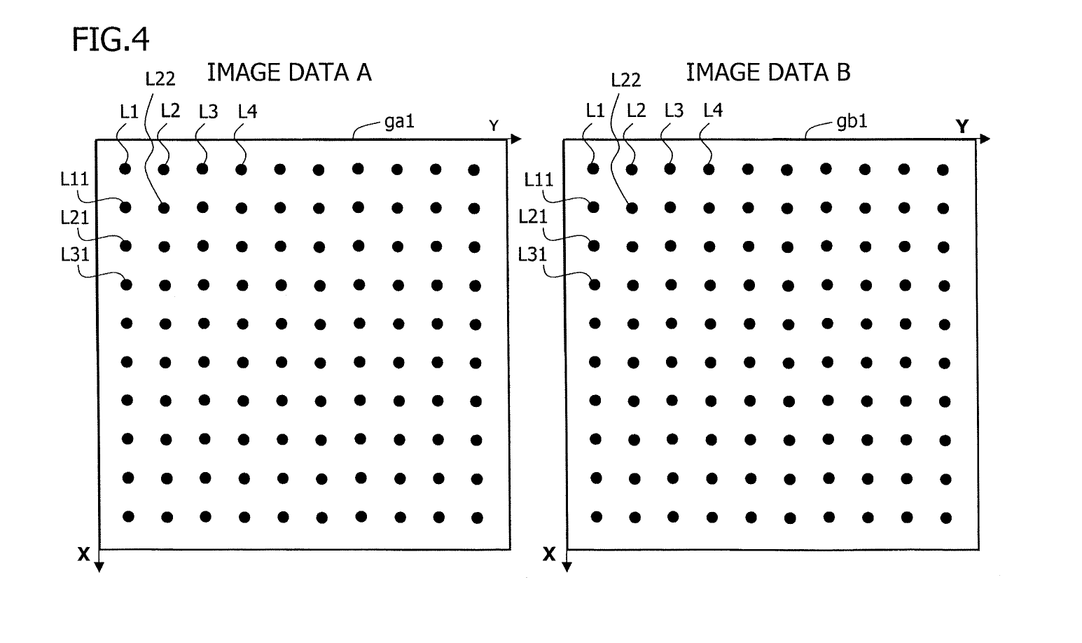

FIG. 4 is a diagram illustrating image data A ga1 and image data B gb1 which are generated by the imaging devices A and B. The image data A ga1 and the image data B gb1 in the diagram represent image data in a case where there is no objects in the three-dimensional space that is an imaging object, whereby downward represents an X-axis direction and rightward represents a Y-axis direction. In FIG. 4, since an object with a height is not present in the three-dimensional space that is an object for image, the spotlights in the image data A ga1 and the image data B gb1 have not moved and are at regular intervals. In addition, in the example, the intervals between projected spotlights are, for example, 30 cm, and the intervals between spotlights in the image data A ga1 and the image data B gb1 are, for example, 60 pixels.

[Spot Number and Coordinates]

Furthermore, in FIG. 4, a spot number is assigned to each spotlight. For example, a top left spotlight L1 has a spot number of 1 and a spotlight L2 adjacent to the right of the top left spotlight L1 has a spot number of 2. In addition, a spotlight L11 below the top left spotlight L1 has a spot number of 11. The same applies to the other spotlights. Furthermore, coordinates are associated with each spotlight. For example, the coordinates of the spotlight L1 is (1, 1), and the coordinates of the spotlight L2 is (1, 2). In a similar manner, the coordinates of the spotlight L11 is (2, 1).

As described earlier, when an object is present in the three-dimensional space that is an imaging object, a spotlight projected onto the object moves from an original projected position. Next, an example of a movement of a spotlight will be described.

[Movement of Spotlight]

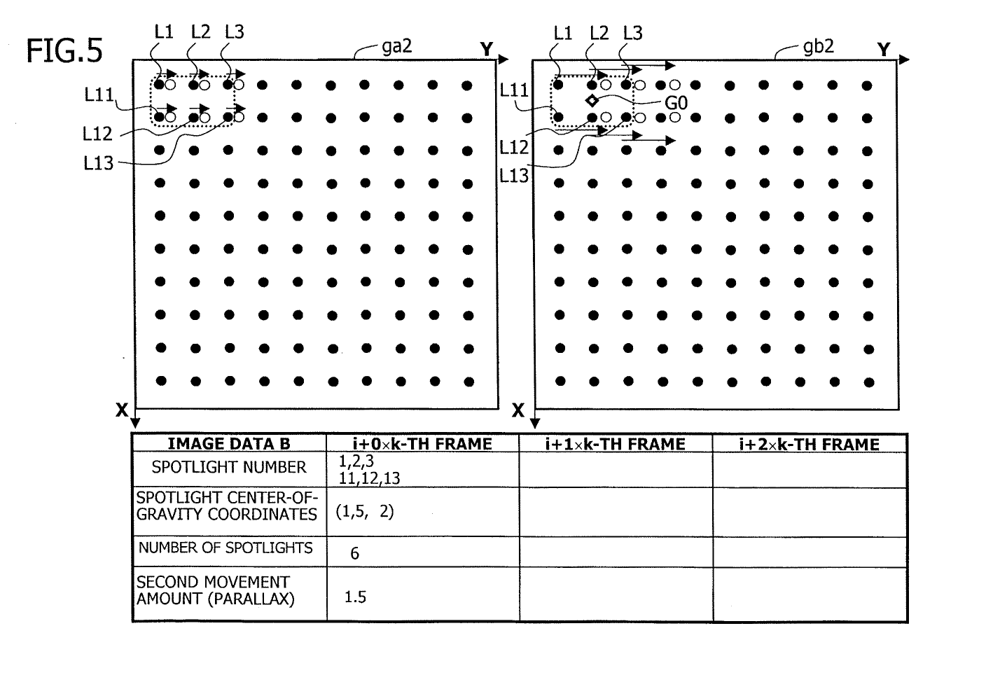

FIG. 5 is a diagram illustrating movements of spotlights in image data A ga2 and the image data B gb2 when an object is present. In the diagram, objects with a height are present at positions of the spotlights L1, L2, L3, L11, L12, and L13. Accordingly, in the image data A ga2 and the image data B gb2, positions of the spotlights L1, L2, L3, L11, L12, and L13 projected onto objects have moved by a distance (parallax) corresponding to heights of the objects. In this case, the movement amounts (parallax) of the spotlights L1, L2, L3, L11, L12, and L13 in the image data A ga2 are smaller than the movement amounts (parallax) of the spotlights L1, L2, L3, L11, L12, and L13 in the image data B gb2. Hereinafter, a spotlight that has moved will be referred to as a moved spotlight.

As described above, with the image data A ga2 and the image data B gb2, a difference in distances between the projector (pp in FIG. 1) and the imaging device A 14 and the imaging device B 15 results in a difference in movement amounts of the moved spotlights. In the image data B gb2, since the movement amounts of the spotlights are large, a minute change in an object is significantly reflected in the movement amounts. Therefore, in order to detect a change in an object with a high degree of accuracy, a movement amount of a moved spotlight in the image data B gb2 is desirably used. However, a large movement amount of a moved spotlight also means that an overleap phenomenon of a spotlight is more likely to occur.

[Overleap Phenomenon of Spotlight]

An overleap phenomenon of a spotlight is a phenomenon in which a moved spotlight moves by leaping over a spotlight that is adjacent to a corresponding reference spotlight. Accordingly, the moved spotlight ends up being erroneously determined so as to correspond to the spotlight that is adjacent to the reference spotlight. In other words, a search error of an original spotlight corresponding to the moved spotlight occurs. Accordingly, a movement amount of the measured spotlight is inadvertently measured as a small value from the adjacent spotlight. As a result, the movement amount of the moved spotlight is erroneously judged and is not accurately measured.

As described above, with the image data B gb2 of the imaging device B, while a minute change in an object can be detected because a minute motion is significantly reflected in a movement of a spotlight, an overleap phenomenon of the spotlight is more likely to occur. On the other hand, with the image data A ga2, a small movement amount of a spotlight means that although a minute motion is less reflected in the movement of the spotlight, an overleap phenomenon of the spotlight is less likely to occur. In consideration thereof, by using the two pieces of image data A ga2 and the image data B gb2, a search error of an original spotlight corresponding to a moved spotlight which is attributable to an overleap phenomenon is resolved.

In the present embodiment, the spot search device 100 generates a moved spotlight and a first movement amount based on the image data A. In addition, the spot search device 100 generates a second movement amount of the moved spotlight in the image data B based on the first movement amount and the distance between the imaging devices A and B. In other words, the spot search device 100 detects a moved spotlight and a movement amount thereof (a first movement amount) based on the image data A which enables accurate spotlight search. A moved spotlight has the same spotlight number in the image data A and B. Therefore, based on the moved spotlight and the first movement amount detected based on the image data A, the spot search device 100 detects the second movement amount of the same moved spotlight in the image data B.

As described above, by using the image data A generated by the imaging device A which is at a short distance from the projector and in which a moved spotlight has a small movement amount, the moved spotlight and a movement amount of the moved spotlight in the image B can be detected. As a result, the problem caused by an overleap phenomenon of spotlights is resolved. However, the use of two pieces of image data A and B results in a slower processing speed when detecting a moved spotlight and a movement amount thereof in the image data B.

[Outline of Processing by Spot Search Device 100]

In consideration thereof, when a velocity and an area of a moved spotlight calculated from at least two pieces of frame image data in the image data B satisfy reference values, the spot search device 100 according to the present embodiment detects the moved spotlight as a same object moved spotlight group. Next, based on movement information of the same object moved spotlight group, the spot search device 100 predicts a predicted moved spotlight position in a next frame of the same object moved spotlight group.

Accordingly, the spot search device 100 according to the present embodiment enables a search process of a position of a moved spotlight to be performed at high speed and with high accuracy while resolving the problem created by an overleap phenomenon of a spotlight. For example, the spot search device 100 according to the present embodiment is particularly effectively used when detecting a movement or a motion such as a fall of a person moving in a planar direction in a three-dimensional space. Next, an outline of processing by the spot search device 100 according to the present embodiment will be described in sequence.

[Flow of Processing by Spot Search Device 100]

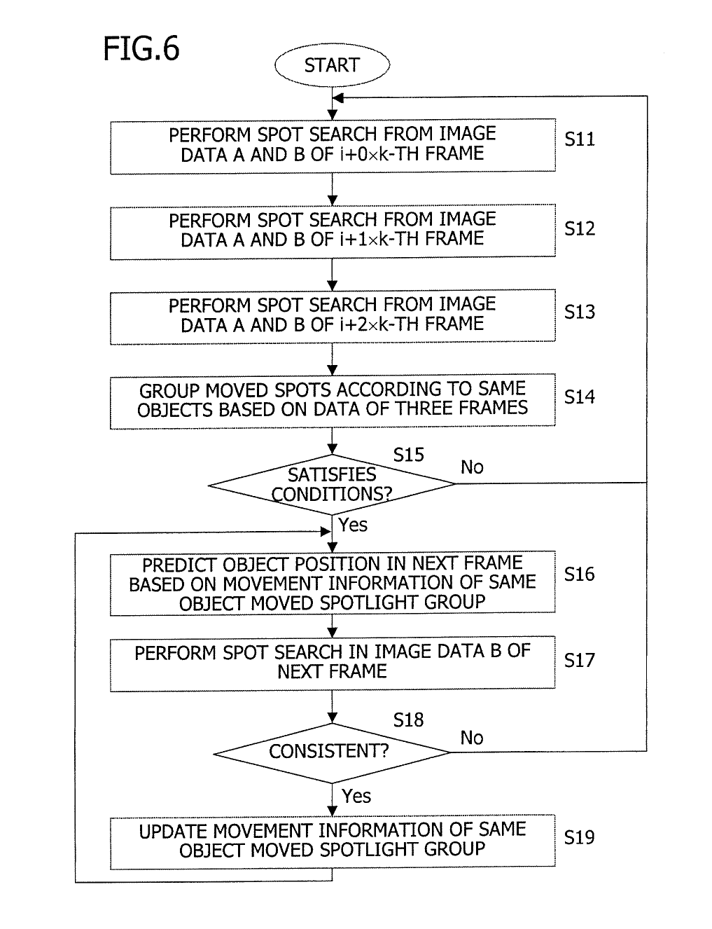

FIG. 6 is a flow chart illustrating processing by the spot search device 100 according to the present embodiment. In FIG. 6, image data of frame i+0×k to frame i+2×k are frame image data captured at different timings.

First, with respect to the i+0×k-th frame image data, the spot search device 100 uses the image data A to calculate a moved spotlight number, moved spotlight center-of-gravity coordinates, the number of moved spotlights, and a second movement amount indicating a movement amount of the moved spotlight in the image data B (S11). Next, in a similar manner, with respect to frame i+1×k after 1×k frames, the spot search device 100 uses the image data A to calculate a moved spotlight number, moved spotlight center-of-gravity coordinates, the number of moved spotlights, and a second movement amount indicating a movement amount of the moved spotlight in the image data B (S12). Furthermore, in a similar manner, with respect to frame i+2×k after 2×k frames, the spot search device 100 uses the image data A to calculate a moved spotlight number, moved spotlight center-of-gravity coordinates, the number of moved spotlights, and a second movement amount indicating a movement of the moved spotlight in the image data B (S13).

Subsequently, based on positions of moved spotlights between image data of the three frames i+0×k to i+2×k in the image data B, the spot search device 100 calculates a velocity of the moved spotlights and an area based on the number of moved spotlights and groups the moved spotlights (S14). In addition, the spot search device 100 judges whether or not the velocity and the area of the moved spotlights satisfy conditions (S15), and when the conditions are satisfied (YES in S15), the spot search device 100 judges that the moved spotlights belong to a same group and detects a same object moved spotlight group. Details of the processing will be described later with reference to a specific example. On the other hand, when conditions are not satisfied (NO in S15), processing returns to step S11.

When a same object moved spotlight group is detected (YES in S15), the spot search device 100 next predicts a position of the same object moved spotlight group in next-frame image data in the image data B based on velocity vector information, an average value of areas, and an average value of the second movement amounts (movement information) of the same object moved spotlight group in the image data of the three frames i+0×k to i+2×k in the image data B (S16). Details of the processing will be described later with reference to a specific example. Next, based on the predicted position of the moved spotlight group, the spot search device 100 searches for a position of the same object moved spotlight group in next-frame image data of the image data B (S17). When the predicted position of the moved spotlight is consistent within a reference value from the position of the same object moved spotlight group in the next-frame image data of the image data B, the positions are judged to be consistent (YES in S18). On the other hand, if not within a reference value, the positions are judged to be inconsistent (NO in S18) and processing returns to step S11.

When the positions are judged to be consistent (YES in S18), based on at least two pieces of latest frame image data in the image data B, the velocity vector information, the average value of areas, and the average value of the second movement amounts (movement information) of the same object moved spotlight group are updated (S19). In addition, based on the updated information, a predicted moved spotlight position of the same object moved spotlight group in image data of a frame after the next is predicted (S16). As long as the predicted moved spotlight position is judged to be consistent within a reference range (YES in S17 and S18), a prediction process based on two pieces of latest frame image data is repeated (S19).

Moreover, in the present embodiment, for example, k=2. In other words, every other frame is represented, such as frame i+0×k representing frame i+0, frame i+1×k representing frame i+2, and frame i+2×k representing frame i+4. This means that in the respective processes of steps S11, S12, and S13, since processing is based on two pieces of image data A and B, the spot search device 100 is only capable of processing at intervals of two pieces of frame image data. On the other hand, in steps S16 and S17, since processing is based on one piece of image data B, a position prediction process of image data can be performed for each frame. Therefore, in the present embodiment, the next-frame image data in which a position of the same object moved spotlight group is predicted in step S16 is not frame image data after two frames but frame image data after one frame.

Next, processes of the respective steps in the flow chart in FIG. 6 will be described with reference to a specific example.

[Image Data of Frame i+0×k (i+0)]

Returning now to FIG. 5, the process of step S11 in the flow chart will be described with reference to a specific example. A table at the bottom of FIG. 5 contains information on a moved spotlight number, moved spotlight center-of-gravity coordinates, the number of moved spotlights, and a second movement amount indicating a parallax of the moved spotlight of image data of frame i+0×k in the image data B.

In step S11, using the image data A ga2, the spot search device 100 calculates a moved spotlight number, moved spotlight center-of-gravity coordinates, the number of moved spotlights, and a second movement amount indicating a movement of the moved spotlight in the image data B gb2. First, based on the image data A ga2 in FIG. 5, the parallax calculating unit 29 of the spot search device 100 generates identification information and a first movement amount of the moved spotlight. In addition, based on the first movement amount and a distance between the imaging devices A and B, the spot searching unit 26 and the parallax calculating unit 29 of the spot search device 100 generates a second movement amount of the same moved spotlight in the image data B gb2.

In the image data A in FIG. 5, there are six moved spotlights L1, L2, L3, L11, L12, and L13 respectively assigned spotlight numbers 1, 2, 3, 11, 12, and 13. This means that the same spotlights L1, L2, L3, L11, L12, and L13 are to move in the image data B. The parallax calculating unit 29 of the spot search device 100 first calculates the first movement amount of the spotlights L1, L2, L3, L11, L12, and L13 in the image data A gat. The calculation of the first movement amount enables identification of a height of an object onto which a spotlight has been projected. Subsequently, based on the first movement amount or the calculated object height, and the distance between the imaging devices A and B, the second movement amount of the spotlights L1, L2, L3, L11, L12, and L13 in the image data B gb2 is calculated using the principle of triangulation. A calculation process of the second movement amount is described in, for example, Japanese Patent Application Laid-open No. 2005-3367.

As described above, the second movement amount of the spotlights L1, L2, L3, L11, L12, and L13 in the image data B can be calculated based on the first movement amount of the spotlights L1, L2, L3, L11, L12, and L13 in the image data A. In this example, the second movement amount of the moved spotlights L1, L2, L3, L11, L12, and L13 in the image data B is 1.5. This means that, in the image data B, the spotlights L1, L2, L3, L11, L12, and L13 have moved rightward by 1.5 coordinates from their original positions.

In addition, the spot search device 100 generates information on coordinates of a center of gravity G0 of the moved spotlights and the number of moved spotlights. Moved spotlight center-of-gravity coordinates are calculated by dividing a cumulative total of moved spotlight coordinates by the number of moved spotlights. In this example, the coordinates of the spotlight L1 is (1, 1), the coordinates of the spotlight L2 is (1, 2), and the coordinates of the spotlight L3 is (1, 3). In a similar manner, the coordinates of the spotlight L11 is (2, 1), the coordinates of the spotlight L12 is (2, 2), and the coordinates of the spotlight L13 is (2, 3). In this case, the cumulative total of the coordinates is (9, 12). Therefore, by dividing the coordinates (9, 12) by the number of moved spotlights 6, coordinates (1.5, 2) of the center of gravity G0 is calculated. In addition, the second movement amount indicating a parallax of the moved spotlights is calculated by dividing a sum of the second movement amounts of the moved spotlights by the number of moved spotlights 6. For example, when the respective second movement amounts of the moved spotlights are 1.5, 1.5, 1.5, 1.4, 1.3, and 1.8, a second movement amount 1.5 is calculated by dividing a total value 9 by 6.

As described above, the moved spotlight numbers 1, 2, 3, 11, 12, and 13, the moved spotlight center-of-gravity coordinates (1.5, 2), the number of moved spotlights 6, and the second movement amount 1.5 in the image data B gb2 are generated. Subsequently, moved spotlight numbers, moved spotlight center-of-gravity coordinates, the number of moved spotlights, and the second movement amount are generated for image data of a next frame i+1×k in the image data B (step S12).

[Image Data of Frame i+1×k (i+2)]

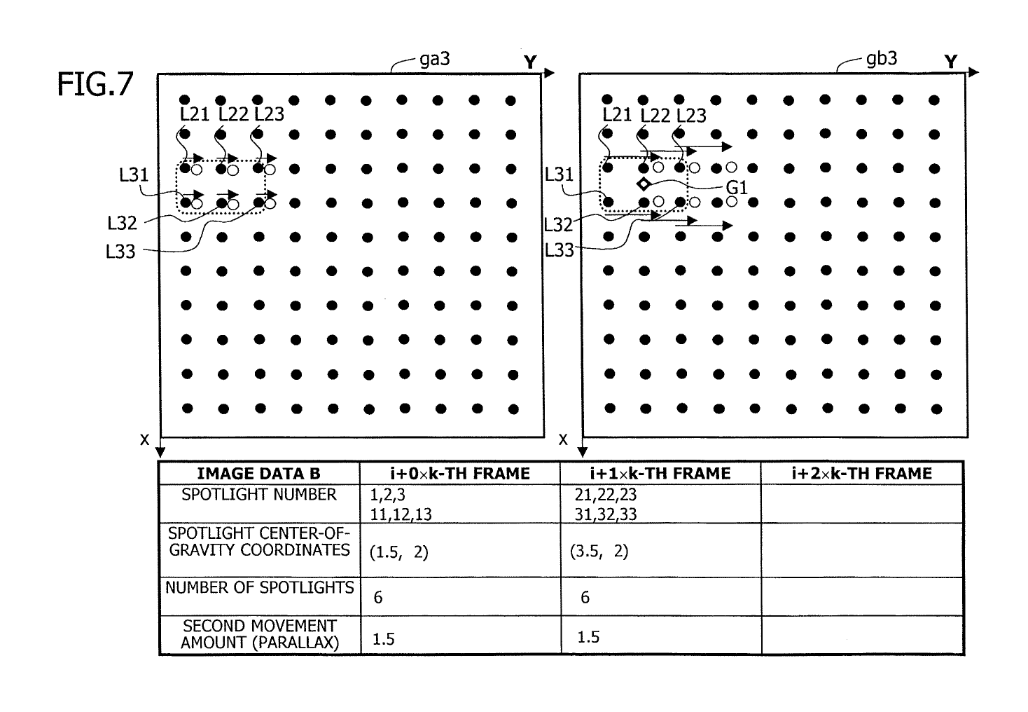

FIG. 7 is an example diagram illustrating image data ga3 and gb3 of the frame i+1×k which correspond to image data A and B. In addition, in this example, an object has moved along the X-axis (downward) from the image data of the i+0×k-th frame in FIG. 5 to the image data of the i+1×k-th frame in FIG. 7. In the image data A ga3 in FIG. 7, there are six moved spotlights L21, L22, L23, L31, L32, and L33 respectively assigned spotlight numbers 21, 22, 23, 31, 32, and 33. The number of moved spotlights is the same as in frame i+0×k.

In a similar manner to FIG. 5, a second movement amount of the moved spotlights L21, L22, L23, L31, L32, and L33 in the image data B is generated based on a first movement amount of the moved spotlights L21, L22, L23, L31, L32, and L33 in the image data A ga3 and the distance between the imaging devices A and B. Accordingly, the second movement amount 1.5 of the moved spotlights L21, L22, L23, L31, L32, and L33 is calculated. In addition, (3.5, 2) is obtained as coordinates of a center of gravity G1 of the moved spotlights. As a result, the moved spotlight numbers 21, 22, 23, 31, 32, and 33, the moved spotlight center-of-gravity coordinates (3.5, 2), the number of moved spotlights 6, and the second movement amount 1.5 in the image data B gb3 of the frame i+1×k are generated.

Subsequently, moved spotlight numbers, moved spotlight center-of-gravity coordinates, the number of moved spotlights, and the second movement amount are generated for image data of a next frame i+2×k in the image data B (step S13). In a similar manner, the object moves further along the X-axis (downward) from image data of the i+1×k-th frame to image data of a next i+2×k-th frame in FIG. 7.

[Image Data of Frame i+2×k (i+4)]

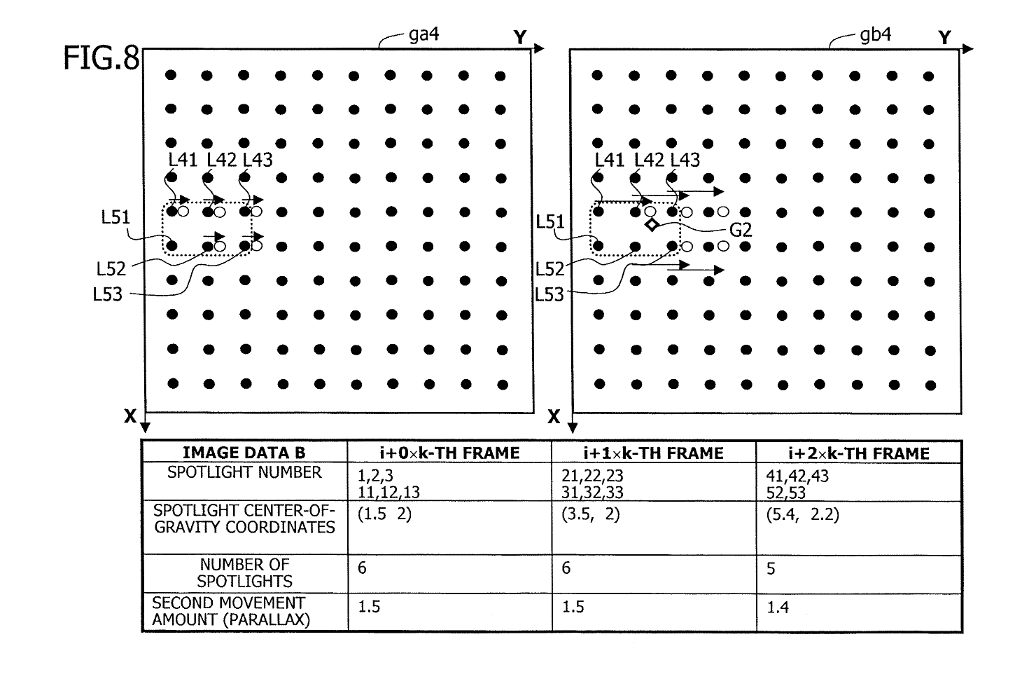

FIG. 8 is an example diagram illustrating image data ga4 and gb4 of the frame i+2×k which correspond to image data A and B. In the image data A ga4 in FIG. 8, there are six moved spotlights L41, L42, L43, L52, and L53 respectively assigned spotlight numbers 41, 42, 43, 52, and 53. Note that the number of moved spotlights has changed from 6 to 5 in the image data A ga4 in FIG. 8.

In a similar manner to FIGS. 5 and 7, a second movement amount of the moved spotlights L41, L42, L43, L52, and L53 in the image data B gb4 is generated based on a first movement amount of the moved spotlights L41, L42, L43, L52, and L53 in the image data A ga4 and the distance between the imaging devices A and B. Accordingly, the second movement amount 1.4 of the moved spotlights L41, L42, L43, L52, and L53 is calculated. In addition, (5.4, 2.2) is obtained as coordinates of a center of gravity of the moved spotlights. As a result, the moved spotlight numbers 41, 42, 43, 52, and 53, the coordinates of the center of gravity G2 of the moved spotlights (5.4, 2.2), the number of moved spotlights 5, and the second movement amount 1.4 of the frame i+2×k in the image data B are generated.

As described above, information on the moved spotlight numbers, the centers of gravity of the moved spotlights, the number of moved spotlights, and the second movement amounts of three pieces of frame image data in the image data B are generated. Moreover, while information is generated with respect to three pieces of frame image data in the image data B in this example, information need only be generated on at least two pieces of frame image data. Subsequently, the spot search device 100 detects a same object moved spotlight group based on a velocity and an area of moved spotlights calculated from image data of three frames (at least two frames) in the image data B (S14 and S15 in FIG. 6).

[Judgment of Same Object Moved Spotlight Group]

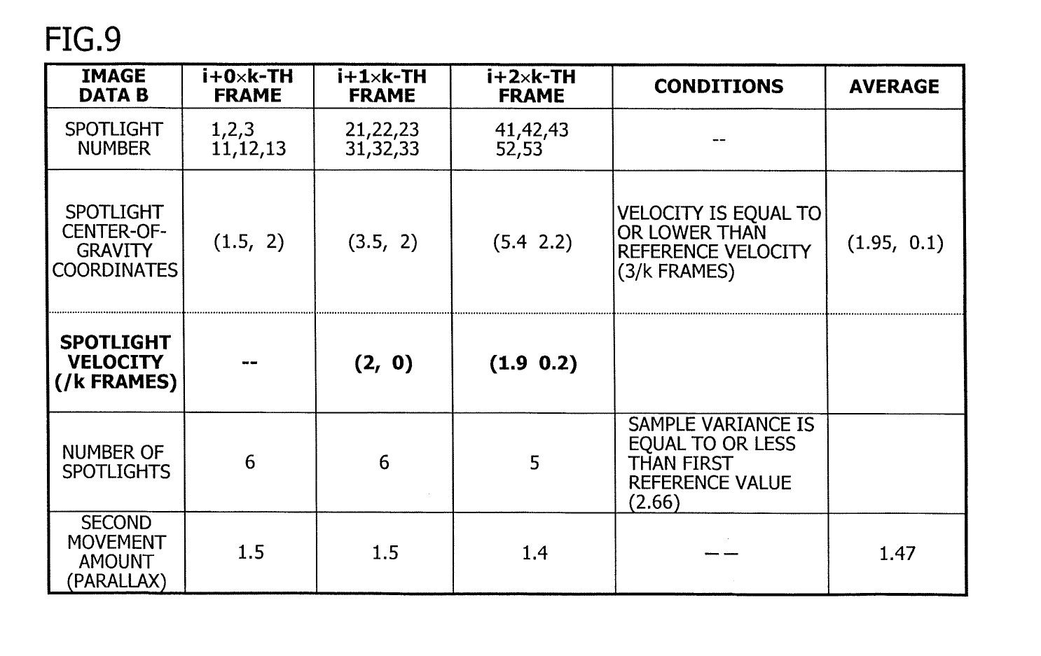

FIG. 9 is a diagram illustrating a detection process of a same object moved spotlight group. A table in FIG. 9 contains information on the moved spotlight numbers, the centers of gravity of the moved spotlights, the number of moved spotlights, and the second movement amounts of image data from frame i+0×k to i+2×k described with reference to FIGS. 5, 7, and 8.

The spot grouping unit 30 of the spot search device 100 detects moved spotlights as a same object moved spotlight group when a velocity and an area of moved spotlights calculated from at least two pieces of object frame image data satisfy reference values. Specifically, for example, when the velocity of a moved spotlight between frame image data is slower than a reference velocity and a degree of dispersion of the area of the moved spotlight is within a first reference degree, the moved spotlight is judged to be a same object moved spotlight group. Accordingly, based on a movement velocity and the area of moved spotlights, the spot search device 100 is capable of identifying a cluster of one or a plurality of moved spotlights which is projected on an object that can be considered to be the same and which moves, in an efficient and simple manner.

In this example, the reference velocity is 3/k frames and the first reference degree is 2.66. The reference velocity is adjusted based on, for example, a maximum velocity of an object which is set in advance. For example, when a target object is an elderly person, even though movement velocity may decline, it is hard to imagine movement occurring at a velocity exceeding a maximum velocity with the exception of cases such as a fall. Therefore, by taking cases such as a fall into consideration and setting a reference velocity based on a maximum velocity, a same object moved spotlight group can be detected in an efficient manner.

Moreover, in this example, the spot search device 100 detects a moved spotlight as the same object moved spotlight group when the velocity of the moved spotlight is within a reference velocity and a degree of dispersion of the area of the moved spotlight satisfies a first reference degree. However, the spot search device 100 may further detect a same object moved spotlight group, based on a dispersion of the second movement amount of the moved spotlight. Specifically, the spot search device 100 detects a moved spotlight as the same object moved spotlight group when a degree of dispersion of the second movement amount of the moved spotlight satisfies a second reference value. Therefore, when a degree of dispersion of height based on the second movement amount is further within a second reference degree, the moved spotlight is judged to be the same object moved spotlight group. Accordingly, based on a movement velocity, an area, and height or, in other words, based on the movement velocity and a volume of the moved spotlights, the spot search device 100 is capable of identifying a cluster of one or a plurality of moved spotlights which is projected on an object that can be considered to be the same and which moves, in a more efficient manner.

[Calculation of Velocity of Moved Spot]

First, a calculation process of a velocity of a moved spotlight in frame image data will be described. In this example, for example, the center of gravity of the moved spotlight has moved from coordinates (1.5, 2) to coordinates (3.5, 2) from the image data of the frame i+0×k to the image data of the frame i+1×k. In other words, a movement equating to coordinates (2, 0) has occurred. Accordingly, the velocity (distance) of the moved spotlight is calculated as 2/k frames. In a similar manner, in image data B, a velocity of the moved spotlight from the image data of the frame i+1×k to the image data of the frame i+2×k is calculated. In the image data B, the center of gravity of the moved spotlight has moved from coordinates (3.5, 2) to coordinates (5.4, 2.2) from the image data of the frame i+1×k to the image data of the frame i+2×k. In other words, a movement equating to coordinates (1.9, 0.2) has occurred. Accordingly, the velocity (distance) of the moved spotlight is calculated as 1.91/k frames. In this example, velocities (2/k frames and 1.91/k frames) are within the reference value of 3/k frames and therefore satisfy conditions.

[Calculation of Sample Variance]

Next, a calculation process of a degree of dispersion of an area of moved spotlights will be described. Equation 1 is a formula for calculating a sample variance. Specifically, with Equation 1, a sample variance value is calculated by dividing a cumulative addition value of square values of a difference between an average value of the numbers of moved spotlights and each number of spotlights by the number of frames. In this example, the numbers of spotlights of the respective pieces of frame image data are 6, 6, and 5. Therefore, based on Equation 1, a dispersion value is calculated as 0.22. In this case, since the dispersion value is within the first reference value of 2.66, conditions are satisfied.

$$\begin{matrix}[ Expression 1 ] & \\ {S}^{2} = \frac{1}{n} {\sum }_{i = 1}^{n} {( \overline{x} - {x}_{i} )}^{2} & ( 1 )\end{matrix}$$

Therefore, with respect to the image data of the frame i+0×k to the image data of the frame i+2×k in the image data B, the velocity of moved spotlights based on frame image data is within a reference velocity and a degree of dispersion of the area satisfies a first reference degree. As a result, moved spotlights in the image data of the frame i+0×k to the image data of the frame i+2×k are detected as a same object moved spotlight group (YES in S15). Based on movement information indicating a feature amount of the same object moved spotlight group, the spot coordinate predicting unit 32 of the spot search device 100 predicts a position of the same object moved spotlight group in next-frame image data in the image data B (S16). First, the spot search device 100 generates movement information including velocity vector information of the same object moved spotlight group, an average value of areas, and an average value of the second movement amounts of the image data of the frame i+0×k to the image data of the frame i+2×k in the image data B.

[Generation of Movement Information]

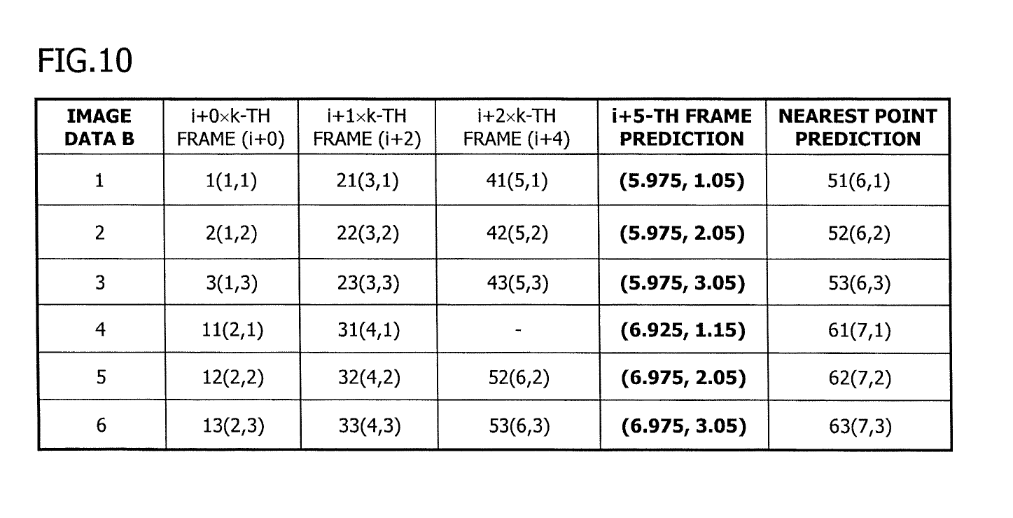

FIG. 10 is a diagram illustrating a process of predicting a position of a same object moved spotlight group in next-frame image data based on the movement information of the same object moved spotlight group. A table in FIG. 10 includes prediction information of a moved spotlight in image data of a next frame i+0×k+1 (i+5) in addition to moved spotlight information of the image data of the frame i+0×k (i+0) to the image data of the frame i+2×k (i+4) in the image data B.

[Average Value of Velocity Vectors]

A case where an average value of velocity vectors of a same object moved spotlight group in three pieces of frame image data is used as velocity vector information will now be described. As described earlier, since the center of gravity of the moved spotlights has moved from coordinates (1.5, 2) to coordinates (3.5, 2) from the image data of the frame i+0×k to the image data of the frame i+1×k, a velocity vector of (2, 0)/k frames is obtained. In addition, since the center of gravity of the moved spotlights has moved from coordinates (3.5, 2) to coordinates (5.4, 2.2) from the image data of the frame i+1×k to the image data of the frame i+2×k, a velocity vector of (1.9, 0.2)/k frames is obtained. Consequently, an average value of the two velocity vectors (2, 0) and (1.9, 0.2) is obtained as (1.95, 0.1). A velocity vector of (1.95, 0.1)/k frames means that a coordinate position is advanced by 1.95 in the X-axis direction and 0.1 in the Y-axis direction for every k frames.

[Average Value of Areas, Average Value of Second Movement Amounts]

Next, a calculation process of an average value of areas of a same object moved spotlight group in frame image data will be described. In this example, the numbers of spotlights in the same object moved spotlight group of the respective pieces of frame image data are 6, 6, and 5. Therefore, an average value of the numbers of spotlights is calculated as 5.66 (=17/3). In addition, a calculation process of an average value of second movement amounts of the same object moved spotlight group in frame image data will be described. In this example, the second movement amounts in the respective pieces of frame image data are 1.5, 1.5, and 1.4. Therefore, an average value of the second movement amounts is calculated as 1.47 (=4.4/3).

[Position Prediction]

The spot coordinate predicting unit 32 of the spot search device 100 predicts a position of a same object moved spotlight group in next-frame image data based on a position of the same object moved spotlight group in latest frame image data in the image data B and the generated movement information. Specifically, as a predicted moved spotlight position, the spot search device 100 predicts a position which corresponds to the area and which is obtained by adding a velocity vector based on an average value of the velocity vectors and corresponding to a ratio between first and second numbers of frames and an average value of the second movement amounts to a position of the same object moved spotlight group in the latest frame image data in the image data B.

As described earlier, the processes in steps S11 to S13 are performed every k frames (k=2, the first number of frames). This is because the processes in steps S11 to S13 are based on two pieces of image data A and B and are more time-consuming, and the processes are not performed every frame. In contrast, in step S16, a position of the same object moved spotlight group in the next-frame image data can be predicted based solely on the image data B. Therefore, processing is faster than when based on two pieces of image data. In other words, a position of the same object moved spotlight group in frame image data after one frame (the second number of frames) that occurs earlier than after two frames (the first number of frames) can be predicted. Accordingly, the spot search device 100 converts a velocity vector per image data of k frames (the first number of frames) into a velocity vector per image data of one frame (the second number of frames).

Specifically, in this example, an average value (1.95, 0.1) of velocity vectors per the second number of frames (1 in this example) is multiplied by “the second number of frames/the first number of frames (2 in this example)” to calculate an average value (0.975 (=1.95×½), 0.05 (=0.1×½)) of velocity vectors per the second number of frames. This means that, after one frame, the same object moved spotlight group advances its position by a velocity vector of (0.975, 0.05). Moreover, the first and second number of frames may take other values. For example, the first number of frames may be 3 and the second number of frames may be 2.

In addition, a velocity vector (0.975, 0.05)/1 frame that has been converted in accordance with a scale of the second number of frames is added to coordinates of the moved spotlight number in image data gb4 of a latest frame i+2×k (i+4) in the image data B. Specifically, for example, the velocity vector (0.975, 0.05)/1 frame is added to coordinates (5, 1) of the spotlight L41 to calculate predicted coordinates (5.975, 1.05) of the moved spotlight in next-frame image data in the image data B. In a similar manner, the velocity vector (0.975, 0.05)/1 frame is added to coordinates of the respective moved spotlights in the image data gb4 of the latest frame i+4 (i+2×k) in the image data B. Accordingly, coordinates (5.975, 1.05), (5.975, 2.05), (5.975, 3.05), (6.975, 2.05), and (6.975, 3.05) of the respective moved spotlights in image data of a next frame i+5 (=i+4+1) in the image data B are predicted.

In addition, an average number of spotlights in an area of the same object moved spotlight group is 5.66. Therefore, it is assumed that the number of spotlights of the same object moved spotlight group is also 5.66 or, in other words, 6 in the image data of the next frame i+5 of the image data B. Accordingly, the spot search device 100 performs position prediction of a moved spotlight yet to be predicted based on moved spotlights in the image data of the immediately previous frame i+1×k in which the number of moved spotlights is 6. In this example, a moved spotlight corresponding to the moved spotlight L31 in the image data of the immediately previous frame i+1×k has not yet been predicted. Therefore, the spot search device 100 predicts a corresponding position of the moved spotlight L31 in image data of a next frame i+5. Specifically, there are three frames between the frame i+1×k (i+2) and the next frame i+5. Accordingly, the spot search device 100 adds a velocity vector (2.925, 0.15) (=0.975×3, =0.05×3) corresponding to three frames to coordinates (4, 1) of the moved spotlight L31 in the image data of the frame i+1×k (i+2) to calculate coordinates (6.925, 1.15).

Next, a closest spotlight is identified from the calculated coordinates (5.975, 1.05), (5.975, 2.05), (5.975, 3.05), (6.925, 1.15), (6.975, 2.05), and (6.975, 3.05). Specifically, the spotlight L51 corresponding to coordinates (6, 1) is closest to the coordinates (5.975, 1.05). In a similar manner, the spotlight L52 corresponding to coordinates (6, 2) is closest to the coordinates (5.975, 2.05). Accordingly, numbers 51, 52, 53, 61, 62, and 63 of spotlights L51, L52, L53, L61, L62, and L63 closest to the calculated coordinates are identified. In this manner, it is predicted that the spotlights after movement are to be eventually positioned at coordinates obtained by adding the average value 1.47 of the second movement amounts to the predicted coordinates of the moved spotlights L51, L52, L53, L61, L62, and L63 in the image data of the next frame i+5 in the image data B.

[Predicted Position: Consistent]

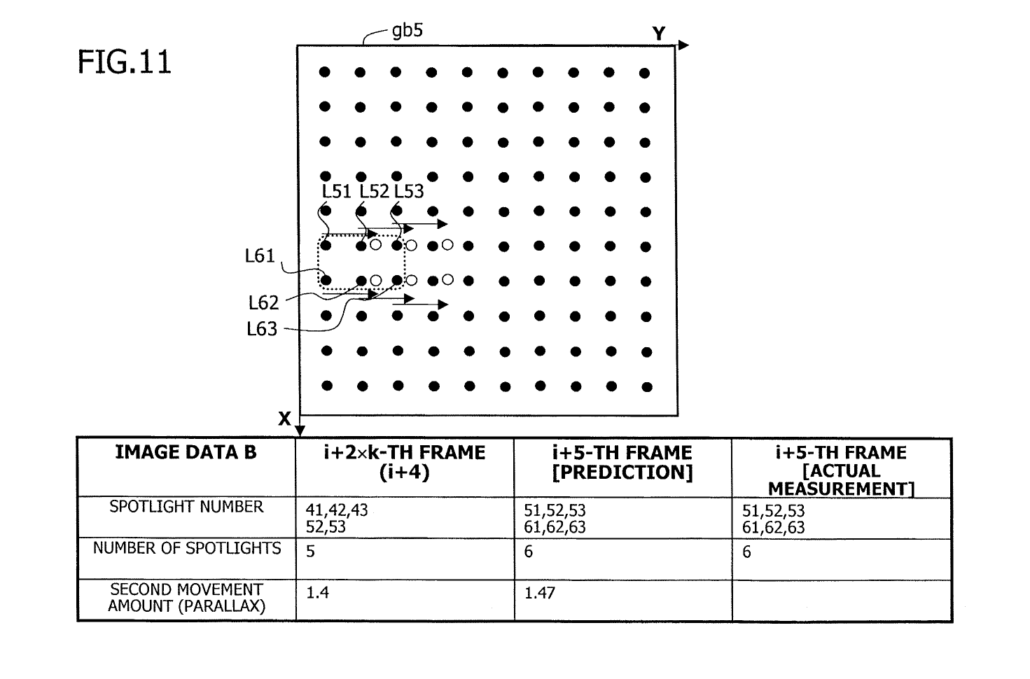

FIG. 11 is a diagram illustrating a case where a predicted moved spotlight position is consistent within a reference value from a position of the same object moved spotlight group in image data gb5 of the next frame i+5 in the image data B. The image data B gb5 in FIG. 11 represents image data of the next frame i+5 in the image data B. In the present embodiment, for example, a predicted position is judged to be consistent when the number of spotlights searched in next-frame image data in the image data B is equal to or greater than 70 percent of the predicted moved spotlights. Alternatively, a predicted position may be judged to be consistent when a position range is expanded by, for example, a proportion corresponding to a reference value from a position range of predicted moved spotlights in the next-frame image data in the image data B and all of the spotlights can be searched.

In the image data gb5 of the next frame i+5 in the image data B in FIG. 11, spotlights are positioned at coordinates obtained by adding the average value 1.47 of the second movement amounts to the predicted coordinates of the moved spotlights L51, L52, L53, L61, L62, and L63. Therefore, the predicted position is judged to be consistent (YES in S18 in FIG. 6). When consistent, subsequently, a predicted moved spotlight position of the same object moved spotlight group in image data of a frame after the next (for example, frame i+6) is predicted based on movement information in image data of at least two latest frames (for example, i+4 and i+5) (S19 in FIG. 6). Subsequently, as long as the predicted moved spotlight position is judged to be consistent within a reference value, a prediction process based on two pieces of latest frame image data is repeated.

Specifically, when it is judged that a predicted moved spotlight position that is predicted based on movement information in the image data of frame i+4 and the image data of frame i+5 is consistent within a reference value in image data of a frame i+6 in the image data B, a predicted moved spotlight position in image data of a frame i+7 is further predicted based on movement information in the image data of frame i+5 and the image data of frame i+6. In other words, the movement information of the same object moved spotlight group is continuously updated based on two pieces of latest frame image data. In this case, position prediction at higher accuracy can be achieved by performing a position prediction in image data of a frame after the next based on latest movement information. In addition, since a position prediction process in image data of a frame after the next is performed every second number of frames, position prediction can be performed at higher accuracy. As described above, the spot search device 100 enables a position prediction process to be performed with higher accuracy and at high speed based on high-accuracy movement information based on high-frequency image data.

Moreover, when consistent (YES in S18 in FIG. 6), the spot search device 100 may generate latest movement information based on a predicted moved spotlight position or may generate latest movement information after acquiring an accurate moved spotlight position based on the predicted moved spotlight position. By using an accurate moved spotlight position as a basis, accuracy of the generated movement information is further improved and accuracy of position accuracy is improved.

[Predicted Position: Inconsistent]

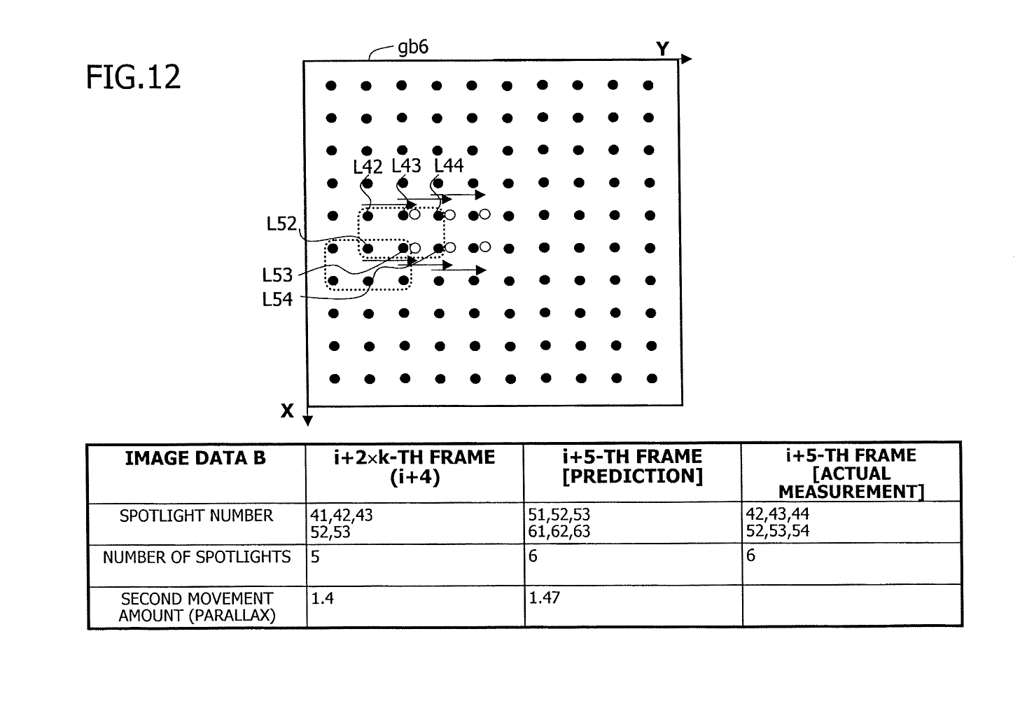

FIG. 12 is a diagram illustrating a case where a predicted moved spotlight position is inconsistent within a reference value from a position of the same object moved spotlight group in image data gb6 of the next frame i+5 in the image data B. The image data B gb6 in FIG. 12 represents image data of the next frame i+5 in the image data B.

In the example illustrated in FIG. 12, the same object moved spotlight group having advanced in the X-axis position up to the image data of frame i+4 changes a movement direction in a Y-axis direction in the image data of frame i+5. Specifically, in the image data B gb6, moved spotlights are L42, L43, L44, L52, L53, and L54. Therefore, only the spotlights L52 and L53 among the predicted moved spotlights L51, L52, L53, L61, L62, and L63 are consistent. In other words, since only two moved spotlights among the six predicted moved spotlights are consistent, a consistency rate is 33%. In this case, since the consistency rate does not exceed the reference value of 70%, the predicted position is judged to be inconsistent (NO in S18 in FIG. 6). At this point, a return is made to step S11 in the flow chart in FIG. 6. A judgment that the predicted position is inconsistent (NO in S18 in FIG. 6) indicates that movement information representing feature information of the same object moved spotlight group has been changed. Therefore, processes of the detection of a same object moved spotlight group and thereafter (S11 to S15 in FIG. 6) are repeated once again.

Moreover, in the present embodiment, a case where the second number of frames (1 in this example) is smaller than the first number of frames (2 in this example) has been described. However, the first number of frames and the second number of frames may be the same. The spot search device 100 according to the present embodiment is capable of performing a spotlight position prediction process at a higher speed by basing the spotlight position prediction process solely on one piece of image data (the second image data). Therefore, even if the first number of frames and the second number of frames are the same, the spot search device 100 enables performance of the computing unit 17 to be devoted to other processes by enabling a spotlight position prediction process to be performed at a higher speed.

[Modifications]

In the embodiment described above, a position of a same object moved spotlight group in next-frame image data in the image data B is predicted based on an average value of velocity vectors of the same object moved spotlight group between pieces of frame image data. However, a position of a same object moved spotlight group in next-frame image data in the image data B may be predicted based on an acceleration vector of the same object moved spotlight group between pieces of frame image data. Performing a position prediction based on an acceleration vector calls for information on moved spotlights based on at least three pieces of frame image data in the image data B.

[Acceleration Vector]

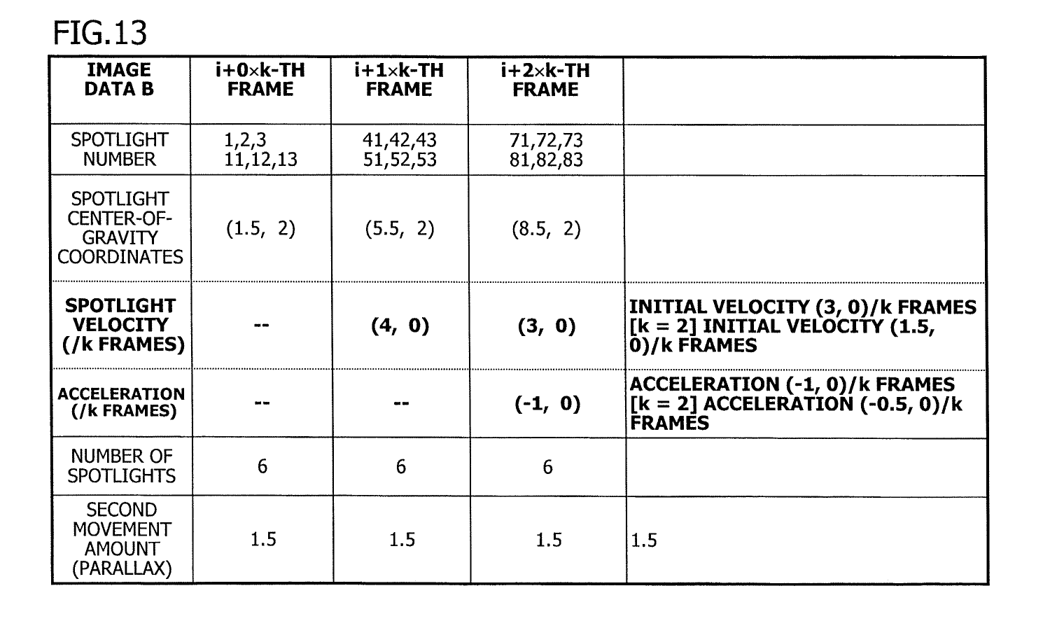

FIG. 13 is a diagram illustrating a calculation process of an acceleration vector of a same object moved spotlight group. A table in FIG. 13 includes a moved spotlight number and coordinate information in image data of a next frame i+5 in addition to the numbers of moved spotlights in the image data of the frame i+0×k (i+0) to the image data of the frame i+2×k (i+4) in the image data B. In this example, a center of gravity of a moved spotlight moves from coordinates (1.5, 2) to coordinates (5.5, 2) from the image data of the frame i+0×k to the image data of the frame i+1×k. Therefore, a velocity vector of (4, 0)/k frames is obtained. In addition, since the center of gravity of the moved spotlight moves from coordinates (5.5, 2) to coordinates (8.5, 2) from the image data of the frame i+1×k to the image data of the frame i+2×k, a velocity vector of (3, 0)/k frames is obtained.

Subsequently, an acceleration vector (−1, 0)/k frames is calculated based on a difference in velocity vectors (4, 0) and (3, 0) between pieces of frame image data. The acceleration vector (−1, 0)/k frames means that velocity vectors in the X-axis direction change by −1 coordinates per image data at intervals of k frames. In this case, an acceleration vector per one frame (the second number of frames) is (−0.5, 0) (k=2). In addition, in this example, a velocity vector (3, 0)/k frames in the image data of a latest frame i+2×k is assumed to be an initial velocity vector. In a similar manner, an initial velocity vector per one frame (the second number of frames) is (1.5, 0).

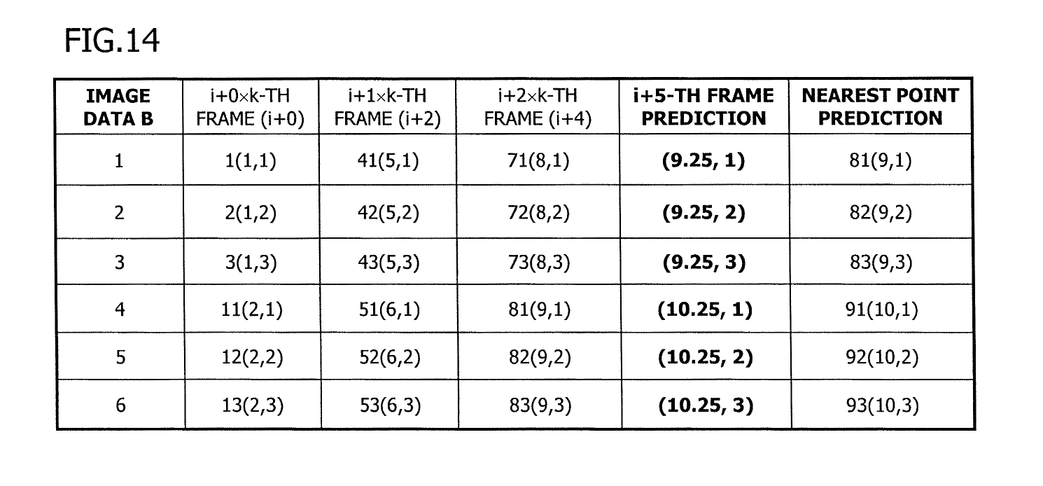

FIG. 14 is a diagram illustrating a process of predicting a position of the same object moved spotlight group in next-frame image data in the image data B based on an acceleration vector. The spot search device 100 generates a predicted position by adding the initial velocity vector (1.5, 0)/1 frame and a movement distance (coordinates) corresponding to 1 frame that is calculated based on the acceleration vector (−0.5, 0)/1 frame to coordinates of the moved spotlight number in image data of the latest frame i+2×k (i+4) in the image data B. The movement distance corresponding to 1 frame is calculated based on an expression “V₀t+½at²”. In this example, V₀=(1.5, 0), a=(−0.5, 0), and t=1. Therefore, a movement distance on the X axis is 1.25 (=1.5-0.25) and a movement distance on the Y axis is 0 (=0+0).

Subsequently, the calculated movement distance (1.25, 0) is added to coordinates of the respective moved spotlight numbers in the image data of the latest frame i+2×k (i+4) in the image data B. Accordingly, coordinates (9.25, 1), (9.25, 2), (9.25, 3), (10.25, 1), (10.25, 2), and (10.25, 3) of the respective moved spotlights in image data of a next frame i+5 are predicted. Next, a closest spotlight is identified from the respective calculated coordinates. As a result, spotlights L81, L82, L83, L91, L92, and L93 are identified. In addition, it is predicted that the spotlights after movement are to be eventually positioned at coordinates obtained by adding an average value 1.5 of the second movement amounts to the predicted coordinates of the moved spotlights L81, L82, L83, L91, L92, and L93 in the image data of the next frame i+5.

As described above, a position of a same object moved spotlight group in next-frame image data in the image data B may be predicted based on an acceleration vector of the same object moved spotlight group based on three pieces of frame image data. Predicting a position of a moved spotlight in next-frame image data based on an acceleration vector enables the position to be predicted with higher accuracy. Moreover, in this example, an acceleration vector (−1, 0)/k frames is calculated based on velocity vectors (4, 0) and (3, 0) between two pieces of frame image data. However, for example, the acceleration vector may be based on four or more pieces of frame image data. In this case, for example, the acceleration vector is calculated based on an average value of a plurality of acceleration vectors.

As described above, the spot search device 100 according to the present embodiment includes a first movement amount generating unit which detects a moved spotlight and calculates a first movement amount based on first image data (image data A) of pattern light generated by a first imaging device (an imaging device A). In addition, the spot search device 100 includes a second movement amount generating unit which calculates a second movement amount of a moved spotlight in second image data (image data B) of pattern light generated by a second imaging device (an imaging device B) based on the first movement amount and a distance between the first imaging device and the second imaging device. Furthermore, the spot search device 100 includes a spotlight position predicting unit.

Using the spotlight position predicting unit, when a velocity and an area of a moved spotlight calculated from at least two pieces of frame image data in the second image data (the image data B) satisfy reference values, the spot search device 100 detects the moved spotlight as a same object moved spotlight group. In addition, based on movement information of the same object moved spotlight group in the second image data, the spot search device 100 predicts a predicted moved spotlight position in next-frame in the second image data of the same object moved spotlight group.

As described above, the spot search device 100 according to the present embodiment resolves the problem due to overleaping of a spotlight by performing a search process of the spotlight based on first and second image data (image data A and B). As a result, an erroneous detection of a second movement amount due to an overleap of a spotlight is avoided and a moved spotlight and a second movement amount in the second image data (image data B) can be generated with high accuracy.

In addition, the spot search device 100 according to the present embodiment detects one or more moved spotlights in the second image data (image data B) detected with high accuracy and whose velocity and area satisfy reference values as a same object moved spotlight group, and predicts a position of the same object moved spotlight group in next-frame image data in the second image data (image data B) based on movement information that is feature information of the same object moved spotlight group. Accordingly, a position of a moved spotlight in next-frame image data in the second image data (image data B) can be predicted without processing the first image data (image data A). In other words, the spot search device 100 is capable of predicting a position of a moved spotlight in the second image data in next-frame image data based on a single piece of image data (the second image data) at high speed.

Furthermore, with the spot search device 100 according to the present embodiment, only a same object moved spotlight group among all spotlights is targeted and a position thereof is searched. In other words, by performing a spot search by targeting only the same object moved spotlight group instead of targeting all spotlights in the second image data, the spot search device 100 is capable of performing a spot search process more efficiently.

As described above, the spot search device 100 according to the present embodiment enables a search process of a position of a spotlight that has moved to be performed at high speed and with high accuracy while resolving the problem created by an overleap phenomenon of a spotlight.

In addition, the spot search device 100 according to the present embodiment further detects a moved spotlight as a same object moved spotlight group, based on a dispersion of a second movement amount of the moved spotlight. Accordingly, the spot search device 100 is capable of detecting one or a plurality of moved spotlights corresponding to an object that can be considered to be the same as a same object moved spotlight group based on a velocity and a volume (area, second movement amount) of moved spotlights.

Furthermore, with the spot search device 100 according to the present embodiment, movement information handled by the spotlight position predicting unit includes velocity vector information, an average value of areas, and an average value of second movement amounts of a same object moved spotlight group. Accordingly, the spot search device 100 sets a velocity vector and a volume (area, second movement amount) of moved spotlights as feature information, and is able to predict a position of the same object moved spotlight group in next-frame image data based on the feature information in an highly accurate and efficient manner.

In addition, with the spot search device 100 according to the present embodiment, processes of the first and second movement amount generating units are performed every first number of frames and a process of the spotlight position predicting unit is performed every second number of frames that is equal to or smaller than the first number of frames. As described earlier, by basing a spotlight position prediction process solely on one piece of image data (second image data), the spot search device 100 is capable of performing the spotlight position prediction process at intervals of image data of every second number of frames. Accordingly, the spotlight position prediction process is performed at a greater frequency and with higher accuracy according to movement information based on high-frequency frame image data. Furthermore, even if the first number of frames and the second number of frames are the same, the spot search device 100 enables performance of the computing unit 17 to be devoted to other processes by enabling the spotlight position prediction process to be performed at a higher speed.

In addition, the spotlight position predicting unit of the spot search device 100 according to the present embodiment predicts, as a predicted moved spotlight position, a position which corresponds to the area and which is obtained by adding velocity vector information in accordance with a ratio of the first and second numbers of frames and an average value of second movement amounts to a position of the same object moved spotlight group in latest frame image data in second image data. Accordingly, based on features of the same object moved spotlight group, the spot search device 100 is capable of efficiently predicting a predicted moved spotlight position of the same object moved spotlight group in next-frame image data of the second image data based solely on the second image data.

Furthermore, with the spot search device 100 according to the present embodiment, velocity vector information in movement information is any of an average value of velocity vectors of a same object moved spotlight group among at least two pieces of frame image data, and an acceleration vector of the same object moved spotlight group among at least three pieces of frame image data. Accordingly, the spot search device 100 is capable of predicting a predicted moved spotlight position of the same object moved spotlight group in second image data of a next frame with high accuracy based on any of a velocity vector or an acceleration vector of the same object moved spotlight group.

In addition, the spotlight position predicting unit of the spot search device 100 according to the present embodiment calculates a velocity based on center-of-gravity positions of the moved spotlight among at least two pieces of frame image data. Accordingly, even if the same object moved spotlight group has a plurality of spotlights, the spot search device 100 is capable of calculating a velocity and velocity vector information in an efficient manner.

Furthermore, when it is judged that a predicted moved spotlight position in the second image data is consistent within a reference value from a position of a same object moved spotlight group in next-frame image data, the spot search device 100 predicts a predicted moved spotlight position of the same object moved spotlight group in image data of a frame after the next based on movement information calculated from at least two pieces of latest frame image data. Subsequently, as long as the predicted moved spotlight position is judged to be consistent within a reference value, the spot search device 100 repeats prediction based on two pieces of latest frame image data.

As described above, as long as the predicted position of a moved spotlight is judged to be consistent within a reference value, the spot search device 100 according to the present embodiment repeats prediction of a position of a moved spotlight based on two pieces of latest frame image data in the second image data. In this case, since movement information of the same object moved spotlight group is continuously updated based on two pieces of latest frame image data in the second image data (image data B), accuracy of the movement information is improved. Accordingly, position prediction accuracy is further improved.

In addition, with the spot search device 100 according to the present embodiment, the first imaging device and the second imaging device may be a same imaging device, and the first image data and the second image data may be image data captured and generated before and after movement of the same imaging device. While a case where imaging devices A and B are used has been illustrated in the present embodiment, two imaging devices need not necessarily be used. A single imaging device may be moved for a same period of time to generate first image data (image data A) and second image data (image data B). Accordingly, a single imaging device may be prepared.

Moreover, a spot search process according to the present embodiment may be stored as a program in a computer-readable storage medium and may be performed by having a computer read and execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A spot search device which searches, based on image data of pattern light including a plurality of spotlights projected in a lattice pattern by a projector, a moved spotlight representing any of the plurality of spotlights that has moved, the spot search device comprising:
a first movement amount generating unit which detects the moved spotlight and calculates a first movement amount based on first image data of the pattern light generated by a first imaging device;
a second movement amount generating unit which, based on the first movement amount and a distance between the first imaging device and a second imaging device, calculates a second movement amount of the moved spotlight in second image data of the pattern light generated by the second imaging device; and
a spotlight position predicting unit which, when a velocity and an area of the moved spotlight calculated from at least two pieces of frame image data in the second image data satisfy reference values, detects the moved spotlight as a same object moved spotlight group and predicts a predicted moved spotlight position of the same object moved spotlight group in a next frame in the second image data, based on movement information of the same object moved spotlight group in the second image data.

2. The spot search device according to claim 1, wherein
the spotlight position predicting unit further detects the moved spotlight as the same object moved spotlight group, based on a dispersion of the second movement amount of the moved spotlight.

3. The spot search device according to claim 1, wherein
the movement information includes velocity vector information, an average value of areas, and an average value of the second movement amounts of the same object moved spotlight group.

4. The spot search device according to claim 3, wherein
processes of the first and second movement amount generating units are performed every first number of frames, and
a process of the spotlight position predicting unit is performed every second number of frames that is equal to or smaller than the first number of frames.

5. The spot search device according to claim 4, wherein
the spotlight position predicting unit predicts, as a predicted moved spotlight position, a position which corresponds to the area and which is obtained by adding velocity vector information in accordance with a ratio of the first and second numbers of frames and an average value of second movement amounts to a position of the same object moved spotlight group in latest frame image data in the second image data.

6. The spot search device according to claim 3, wherein
the velocity vector information in the movement information is any of an average value of velocity vectors of the same object moved spotlight group among at least two pieces of frame image data, and an acceleration vector of the same object moved spotlight group among at least three pieces of frame image data.

7. The spot search device according to claim 1, wherein
the spotlight position predicting unit calculates the velocity based on center-of-gravity positions of the moved spotlight among the at least two pieces of frame image data.

8. The spot search device according to claim 1, wherein
the first imaging device and the second imaging device are a same imaging device, and
the first image data and the second image data are image data captured and generated before and after movement of the same imaging device.

9. A spot search method of searching, based on image data of pattern light including a plurality of spotlights projected in a lattice pattern by a projector, a moved spotlight representing any of the plurality of spotlights that has moved, the spot search method comprising:
detecting the moved spotlight and calculating a first movement amount based on first image data of the pattern light generated by a first imaging device;
calculating, based on the first movement amount and a distance between the first imaging device and a second imaging device, a second movement amount of the moved spotlight in second image data of the pattern light generated by the second imaging device; and
detecting the moved spotlight as a same object moved spotlight group and predicting a predicted moved spotlight position of the same object moved spotlight group in a next frame, based on movement information of the same object moved spotlight group, when a velocity and an area of the moved spotlight calculated from at least two pieces of frame image data in the second image data satisfy reference values.
